(19) United States
(12) Patent Application Publication
(10) Pub. No.: US 2019/0303006 A1
(43) Pub. Date: Oct. 3, 2019

(54) DETERMINING WHEN TO REBALANCE SLICES ACROSS MEMORY DEVICES

(71) Applicant: International Business Machines Corporation, Armonk, NY (US)

(72) Inventor: Ethan S. Wozniak, Park Ridge, IL (US)

(21) Appl. No.: 15/940,581

(22) Filed: Mar. 29, 2018

(51) Int. Cl. G06F 3/06; G06F 12/1072

(52) U.S. Cl. CPC G06F 3/0604; G06F 12/1072; G06F 3/0644; G06F 2212/254; G06F 2212/1041; G06F 2212/154; G06F 3/067

(57) ABSTRACT

A method includes obtaining, by a storage unit, memory mapping data and physical memory data from each of at least a memory mapping threshold number of storage units, where the at least the memory mapping threshold number of storage units does not include the storage unit. The method further includes obtaining first memory mapping data and first physical memory data of the storage unit, and determining an estimated memory remapping based on the first memory mapping data, the first physical memory data, the memory mapping data, and the physical memory data. The method further includes determining a memory remapping cost based on the estimated memory remapping and a memory remapping benefit based on the memory remapping cost. When the memory remapping benefit exceeds a threshold, the method further includes executing the estimated memory remapping of logical address space to physically addressable memory devices within the storage unit.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

Dispersed storage units of a dispersed storage system may rebalance data slices across memory devices for many reasons. By incorporating a broad array of relevant considerations, the storage unit can choose a mapping function that increases benefits and reduces costs.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of storage units of a dispersed storage network (DSN). in accordance with the present invention;

FIG. 10 is a schematic block diagram of a storage unit of a dispersed storage network (DSN) in accordance with the present invention;

FIG. 11 is an example of executing estimated memory remapping within a storage unit of a dispersed storage network (DSN) in accordance with the present invention; and

FIG. 12 is a logic diagram of an example of estimated memory remapping within a storage unit of a dispersed storage network (DSN) in accordance with the present invention.

### DETAILED DESCRIPTION OF THE INVENTION

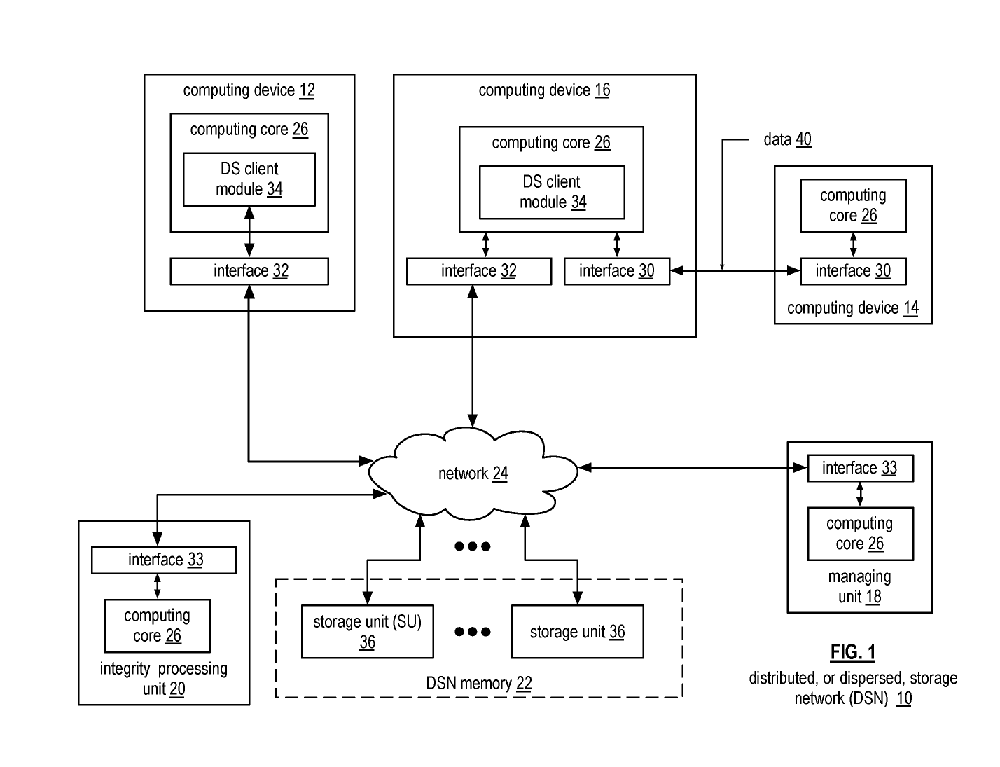

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

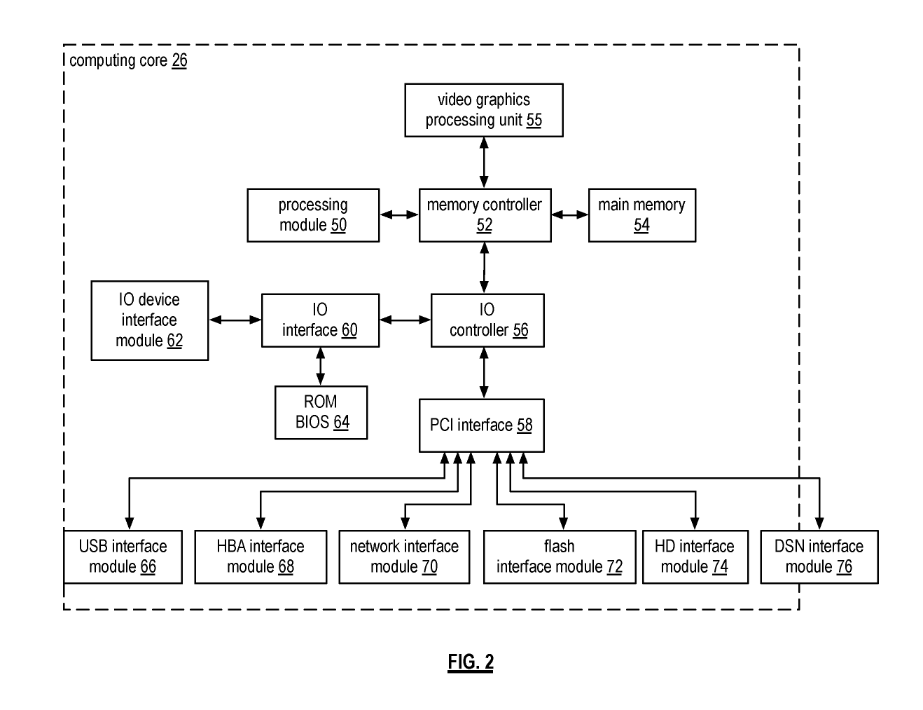

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

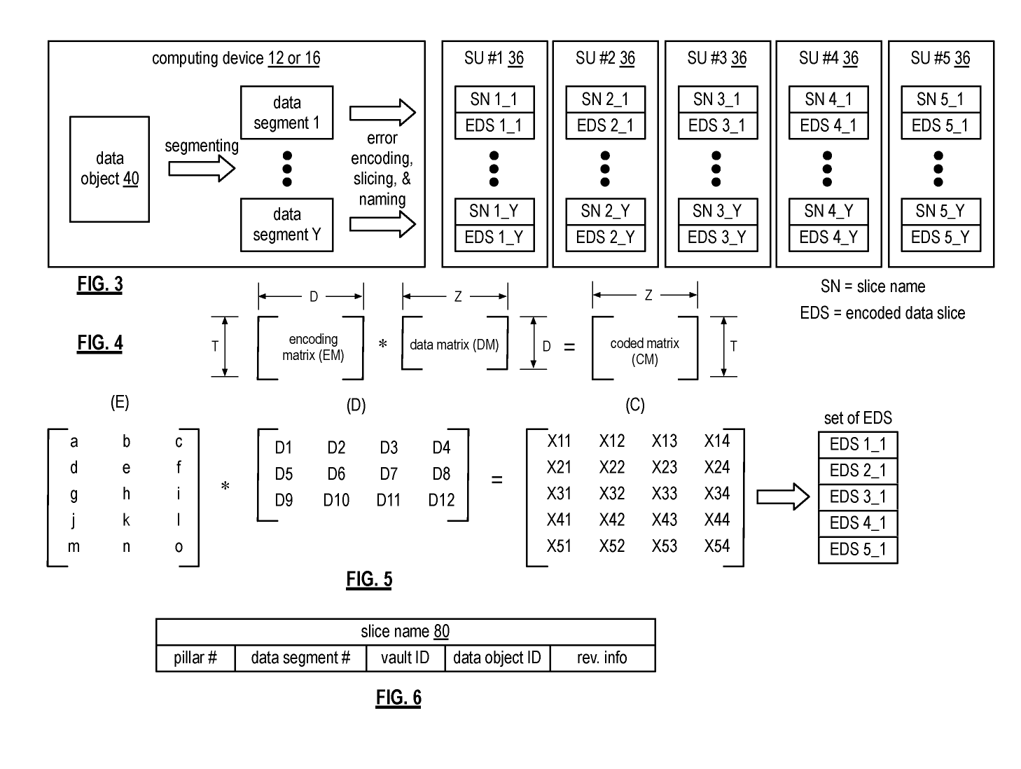

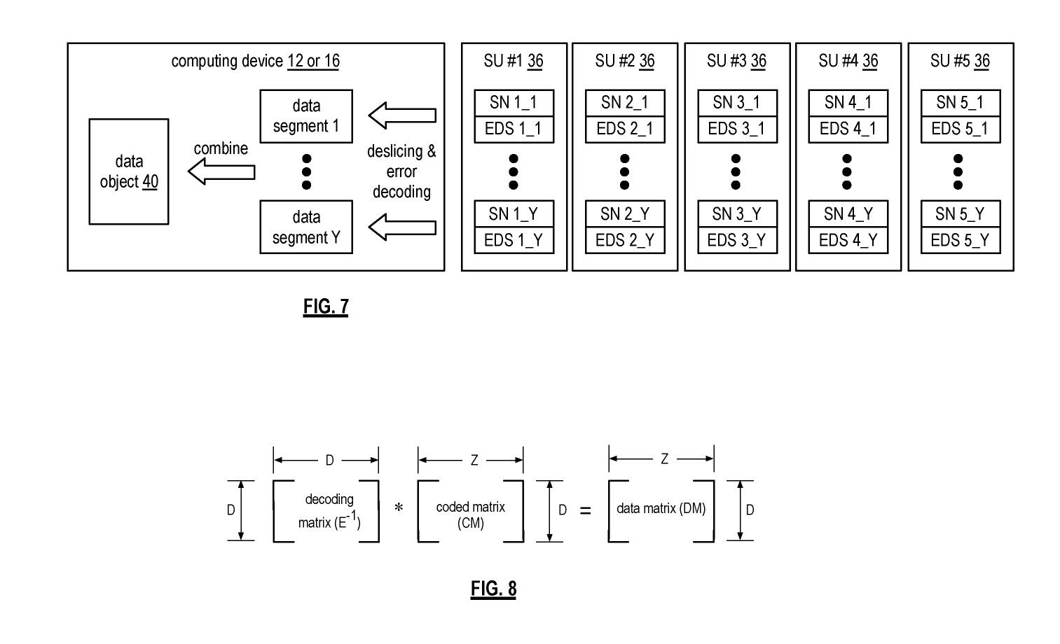

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

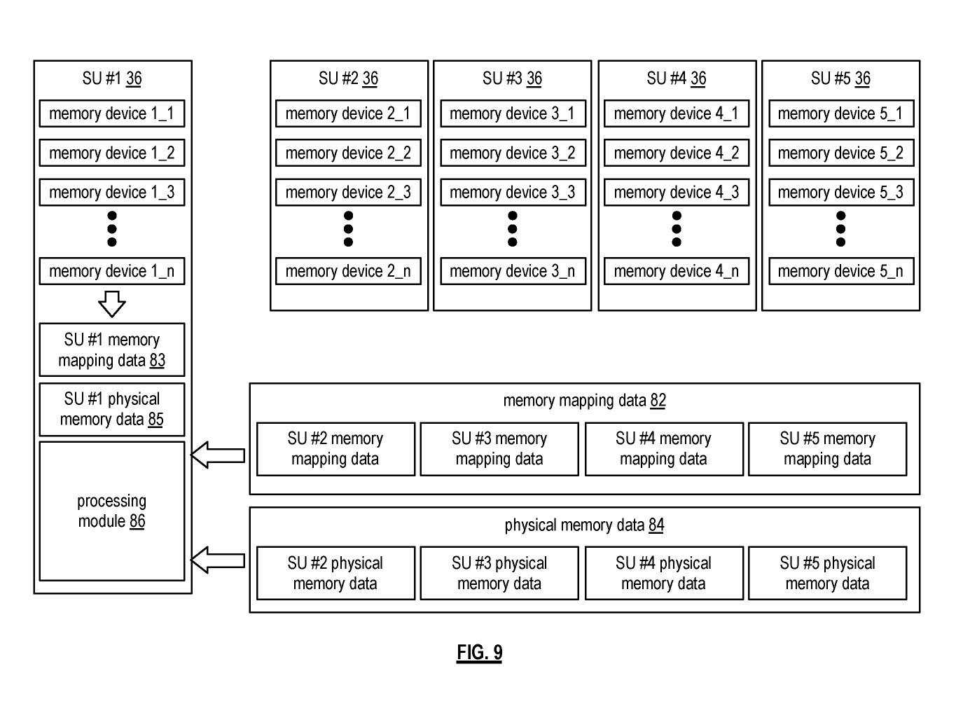

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

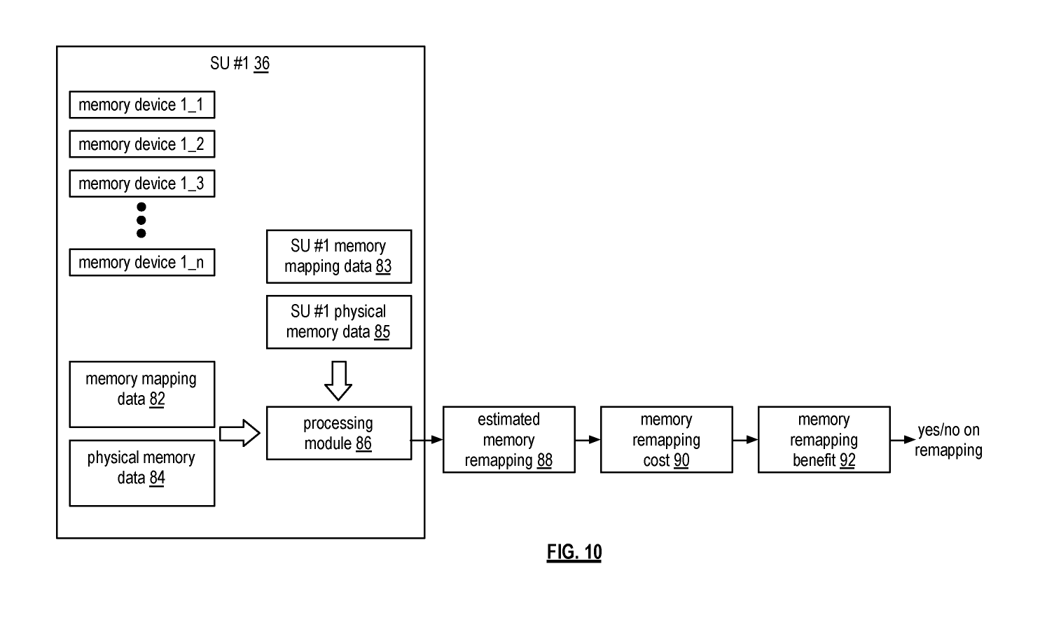

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9 is a schematic block diagram of storage units (SUs #1-5) 36 of a dispersed storage network (DSN). SUs #1-5 are storage units of a set of storage units of the DSN storing a sets of encoded data slices. SU #1 is representative of the other storage units and includes processing module 86 and memory devices 1_1 through 1_n. Each of the other storage units includes its own processing module and memory devices. As shown, SU #2 includes memory devices 2_1 through 2_n, SU #3 includes memory devices 3_1 through 3_n, SU #3 includes memory devices 3_1 through 3_n, SU #4 includes memory devices 4_1 through 4_n, and SU #5 includes memory devices 5_1 through 5_n.

The memory devices in each SU #1-5 may vary in amount, type, age, storage capacity, input-output rate, etc. For example, SU #1 may include two solid state memory devices and two disk drives, while SU #2 may include five solid state memory devices. Each of SU #1-5 has an individual mapping of logical address space to its physically addressable memory devices. The SUs #1-5 are operable to communicate with one another to determine whether remapping of logical address space to physical addressable memory devices is beneficial to an individual storage unit as well as to at least a decode threshold number of storage units of the set of storage units.

In an example of operation, SU #1 obtains memory mapping data 82 and physical memory data 84 from each of at least a memory mapping threshold number of storage units of a set of storage units of the DSN (e.g., two or more of SUs #1-5), which does not include SU #1. As used herein, the memory mapping threshold number is defined as at least a decode threshold minus one. The decode threshold number is a number of encoded data slices of a set of encoded data slices that are needed to recover a data segment of a data object. In this example, the decode threshold is 3 and the pillar width number is 5. Here, SU #1 obtains memory mapping data and physical memory data from four storage units in the set (e.g., SUs #2-5). However, SU #1 could obtain memory mapping data 82 and physical memory data 84 from as little as two (i.e., the decode threshold number minus one) other storage units of the set.

SU #1 obtains memory mapping data from SU #1 83 (e.g., first memory mapping data) and physical memory data from SU #1 85 (e.g., first physical memory data). The memory mapping data 82 includes a logical to physical address memory mapping from each SUs #2-5. The memory mapping data from SU #1 83 includes a logical to physical address memory mapping from SU #1. Each of the logical to physical address mapping of each of SUs #1-5 includes a logical address having a common source name, a common data segment number, and a different pillar number (i.e., SUs #1-5 store encoded data slices from the same data segment of the same data object, refer to FIG. 6 for an example of a DSN address or slice name).

The physical memory data 84 includes physical characteristics of the memory devices in SUs #2-5. The physical memory data from SU #1 85 includes physical characteristics of the memory devices in SUs #1. The physical memory data includes one or more of: the number of memory devices in SUs #1-5, the type of memory devices used by SUs #1-5, read and write rates of each of the memory devices used by SUs #1-5, input-output rates of each of the memory devices used by SUs #1-5, simultaneous read and write capability of each of the memory devices used by SUs #1-5, age of each of the memory devices used by SUs #1-5, estimated life expectancy of each of the memory devices used by SUs #1-5, error rates of each of the memory devices used by SUs #1-5, storage capacity of each of the memory devices used by SUs #1-5, and available memory space of each of the memory devices used by SUs #1-5.

In another embodiment, SU #1 only obtains memory mapping data from SU #1 83 (e.g., first memory mapping data) and physical memory data from SU #1 85 (e.g., first physical memory data) to assess issues within SU #1. SU #1 may assume SUs #2-5 have similar memory mapping data and physical mapping data as the memory mapping data and physical mapping data from SU #1 (e.g., based on default settings) or SU #1 may simply use its own data to rebalance encoded data slices stored within the memory devices of SU #1.

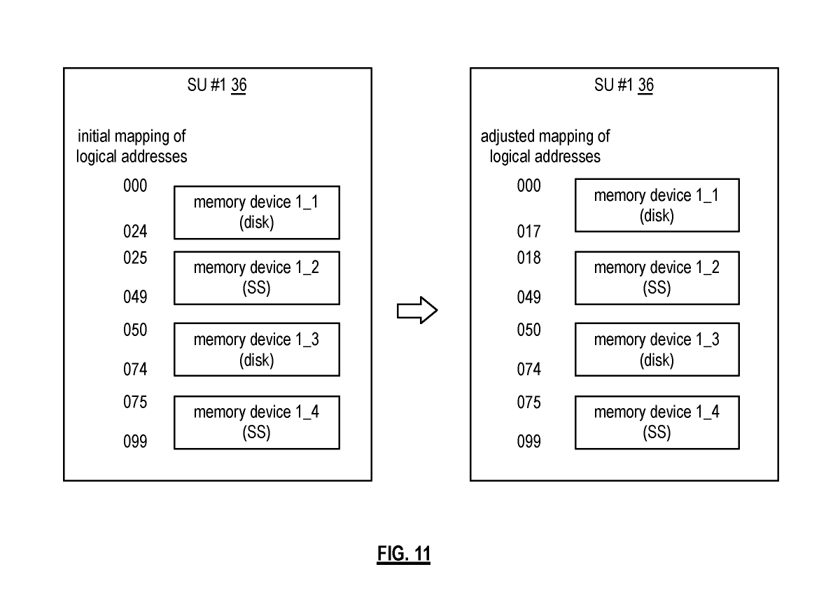

FIG. 10 is a schematic block diagram of a storage unit (SU #1) 36 of a dispersed storage network (DSN). SU #1 includes memory devices 1_1 through 1_n, and processing module 86. As discussed with reference to FIG. 9, SU #1 obtains memory mapping data 82 and physical memory data 84 from the at least the memory mapping threshold number of storage units (e.g., two or more of SUs #2-5). SU #1 also obtains its own memory mapping data 83 (e.g., first memory mapping data) and its own physical memory data 85 (e.g., first physical memory data).

In operation, SU #1 determines an estimated memory remapping 88 based on the first memory mapping data 83, the first physical memory data 85, the memory mapping data 82, and the physical memory data 84. For example, SU #1 determines to relocate an encoded data slice stored on memory device 1_1 to memory device 1_2 within SU #1 when memory device 1_2 is of a same type of memory device as used by two or more of SUs #2-5 to store the at least the memory mapping threshold number of encoded data slices of the set of encoded data slices.

For example, if two or more of SUs #2-5 store the at least the memory mapping threshold number of encoded data slices on solid state memory devices, but SU #1 stores the encoded data slice on a disk drive (e.g., memory device 1_1), it is beneficial to relocate the encoded data slice to a solid state memory device within SU #1 (e.g., memory device 1_2). Storing the at least the memory mapping threshold number of encoded data slices plus the encoded data slice on solid state memory devices prevents a delay in retrieval of a decode threshold number of encoded data slices due to different types of memory and their corresponding different retrieval rates.

As another example, SU #1 determines to relocate an encoded data slice stored on memory device 1_1 to memory device 1_2 within SU #1 when memory device 1_2 has a comparable input-output rate as the memory devices used by SUs #2-5 to store the at least the memory mapping threshold number of encoded data slices. SU #1 may further determine to relocate an encoded data slice of a set of encoded data slices to another memory device within SU #1 when the current memory device is close to failure and/or in need of load rebalancing.

As another example, SU #1 determines to relocate an encoded data slice stored on memory device 1_1 to memory device 1_2 within SU #1 to reduce the number of combinations of memory devices used by SUs #1-5 to store the encoded data slices of the set of encoded data slices. For example, if SUs #2-5 store encoded data slices of the set of encoded data slices on the second memory devices of each SUs #2-5 (e.g., memory device 2_2, memory device 3_2, memory device 4_2, and memory device 5_2), moving the encoded data slice stored on memory device 1_1 to memory device 1_2 reduces the number of combinations of memory devices used across SUs #1-5. When encoded data slices of the same set are stored on random memory devices in each SUs #1-5 there could be some data loss if any three memory devices failed across SUs #1-5 (e.g., when at least three encoded data slices are needed to rebuild the data segment of the data object). For example, three memory devices failing anywhere across SUs #1-5 is much more likely to occur than three first memory devices failing in SUs #1-5. Reducing the combinations of memory devices that encoded data slices are stored in, reduces the chance of data loss.

SU #1 determines a memory remapping cost 90 based on the estimated memory remapping 88. To determine the memory remapping cost 90, SU #1 determines the memory remapping cost of relocating the encoded data slice to the memory device with respect to SU #1 and the memory remapping cost 90 of moving the encoded data slice to the memory device with respect to SUs #2-5. The memory remapping cost 90 includes one or more of processing time to transfer the encoded data slice to the memory device, effect on other operations of SU #1, and change in accessibility of the encoded data slice when stored in the memory device. For example, the memory remapping cost 90 considers whether the new memory device location has a higher or lower error rate, whether the new memory device has a longer or short life expectancy, etc.

SU #1 determines a memory remapping benefit 92 based on the memory remapping cost 90. SU #1 determines the memory remapping benefit 92 by determining a first memory remapping benefit for SU #1 based on the estimated memory remapping, determining a second memory remapping benefit for SUs #2-5 based on the estimated memory remapping, and balancing the first memory remapping benefit, the second memory remapping benefit, the memory remapping cost with respect to SU #1, and the memory remapping cost with respect to SUs #2-5. For example, SU #1 may determine that while there is a benefit to moving an encoded data slice to a new memory device, the cost (e.g., the transfer time) to SU #1 lowers the overall benefit.

In another embodiment, SU #1 obtains its own memory mapping data 83 (e.g., first memory mapping data) and its own physical memory data 85 (e.g., first physical memory data) and determines an estimated memory remapping 88 based on the first memory mapping data 83 and the first physical memory data 85 only. For example, SU #1 may determine to correct imbalances in logical or physical fill levels of the memory devices when a memory device is getting full, SU #1 may determine to correct imbalances in the workload of memory devices when a memory device has a higher workload than others, and SU #1 may determine to move encoded data slices from memory devices that are close to failure. SU #1 determines a memory remapping cost 90 based on the estimated memory remapping 88 with respect to SU #1 (e.g., processing time to transfer a encoded data slice to a memory device, effect on other operations of SU #1, and change in accessibility of a encoded data slice when stored in a new memory device). SU #1 determines a memory remapping benefit 92 based on the memory remapping cost 90. SU #1 determines the memory remapping benefit 92 by determining a first memory remapping benefit for SU #1 based on the estimated memory remapping (e.g., moving encoded data slices stored on memory devices with high workload to improve performance and prevent memory devices with higher workloads from wearing out sooner), and balancing the first memory remapping benefit with the memory remapping cost with respect to SU #1. For example, SU #1 may determine that while there is a benefit to moving an encoded data slice to a new memory device, the cost (e.g., the transfer time) to SU #1 lowers the overall benefit.

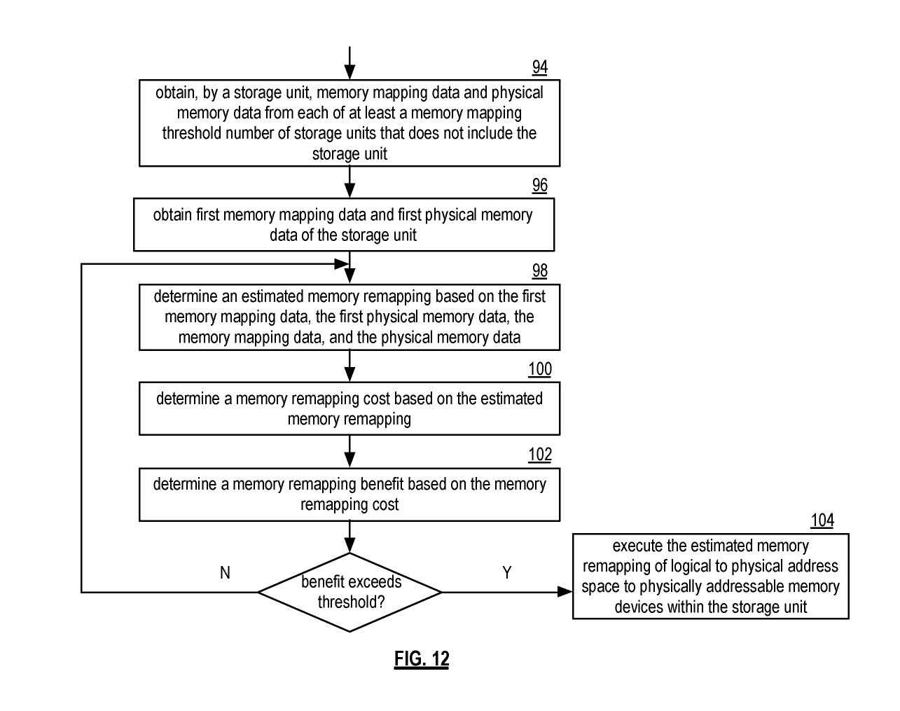

In either embodiment, when the memory remapping benefit 92 exceeds a threshold, SU #1 executes the estimated memory remapping of logical address space to physically addressable memory devices within SU #1. An example of executing the estimated memory remapping of logical address space to physically addressable memory devices within SU #1 is discussed with reference to FIG. 11.

When the memory remapping benefit 92 does not exceed the threshold (e.g., the memory remapping cost 90 is too high), SU #1 determines a second estimated memory remapping based on the first memory mapping data 83, the first physical memory data 85, the memory mapping data 82, and the physical memory data 84. SU #1 determines a second memory remapping cost based on the second estimated memory remapping. SU #1 determines a second memory remapping benefit based on the second memory remapping cost. When the second memory remapping benefit exceeds the threshold, SU #1 executes the second estimated memory remapping of the logical address space to physically addressable memory devices within SU #1.

FIG. 11 is an example of executing estimated memory remapping within a storage unit (SU #1) of a dispersed storage network (DSN). SU #1 determined an estimated memory remapping to move an encoded data slice from memory device 1_1 (a disk drive) to memory device 1_2 (a solid state device). For example, SU #1 determined that SUs #2-5 store encoded data slices from the same segment on solid state devices. Therefore, it would be beneficial to move the encoded data slice from the disk drive (memory device 1_1) to the solid state device (memory device 1_2) (e.g., to improve retrieval time of at least a decode threshold number of encoded data slices).

When the memory remapping benefit of moving the encoded data slice from memory device 1_1 (a disk drive) to memory device 1_2 (a solid state device) exceeds a threshold, SU #1 executes the estimated memory remapping of logical address space to physically addressable memory devices within SU #1. For example, logical addresses 000-024 initially map to the physically addressable space of memory device 1_1, and logical addresses 025-049 initially map to the physically addressable space of memory device 1_2. Moving an encoded data slice from memory device 1_1 to memory device 1_2 results in adjusted logical addresses 000-017 mapped to the physically addressable space of memory device 1_1, and adjusted logical addresses 018-049 mapped to the physically addressable space of memory device 1_2. As part of changing the logical to physical mapping, the encoded data slice is transferred from one memory device to the other. The change in logical to physical addressing may also affect other encoded data slices, which also require transferring from one memory device to another.

FIG. 12 is a logic diagram of an example of estimated memory remapping within a storage unit of a dispersed storage network (DSN). The method begins with step 94 where a storage unit of the DSN obtains memory mapping data and physical memory data from each of at least a memory mapping threshold number of storage units of a set of storage units of the DSN. The at least a memory mapping threshold number of storage units does not include the storage unit. The memory mapping threshold number includes at least a decode threshold minus one number of storage units of the set of storage units. The decode threshold number is a number of encoded data slices of a set of encoded data slices that are needed to recover a data segment of a data object.

The method continues with step 96 where the storage unit obtains first memory mapping data and first physical memory data from the storage unit. The memory mapping data includes a logical to physical address memory mapping from each of the at least the memory mapping threshold number of storage units. The first memory mapping data includes a logical to physical address memory mapping from the storage unit. Each of the logical to physical address mapping of each storage unit of the at least the memory mapping threshold number of storage units and logical to physical address memory mapping from the storage unit includes a logical address having a common source name, a common data segment number, and a different pillar number.

The physical memory data includes one or more of the number of memory devices used by the at least the memory mapping threshold number of storage units, the type of memory devices used by the at least the memory mapping threshold number of storage units, read and write rates used by each of the at least the memory mapping threshold number of storage units, input-output rates of each of the memory devices used by the at least the memory mapping threshold number of storage units, simultaneous read and write capability of each of the memory devices used by the at least the memory mapping threshold number of storage units, age of each of the memory devices used by the at least the memory mapping threshold number of storage units, estimated life expectancy of each of the memory devices used by the at least the memory mapping threshold number of storage units, error rates of each of the memory devices used by the at least the memory mapping threshold number of storage units, storage capacity of each of the memory devices used by the at least the memory mapping threshold number of storage units, and available memory space of each of the memory devices used by the at least the memory mapping threshold number of storage units. The first physical memory data includes all of the above with respect to the memory devices used by the storage unit.

The method continues with step 98 where the storage unit determines an estimated memory remapping based on the first memory mapping data, the first physical memory data, the memory mapping data, and the physical memory data. For example, the storage unit determines to relocate an encoded data slice of a set of encoded data slices of a data object to a memory device within the storage unit when the memory device is of a same type of memory device as used by other storage units of the at least the memory mapping threshold number of storage units to store the at least the memory mapping threshold number of encoded data slices of the set of encoded data slices.

As another example, the storage unit the storage unit determines to relocate an encoded data slice of a set of encoded data slices of a data object to a memory device within the storage unit when the memory device has a comparable input-output rate as the memory devices used by the other storage units to store the at least the memory mapping threshold number of encoded data slices. The storage unit may further determine to relocate an encoded data slice of a set of encoded data slices to a memory device within the storage unit when the current memory device is close to failure and/or in need of load rebalancing. As another example, the storage unit may determines to relocate an encoded data slice of a set of encoded data slices to a memory device within the storage that reduces the number of combinations of memory devices used by other storage units of the at least the memory mapping threshold number of storage units to store the at least the memory mapping threshold number of encoded data slices of the set of encoded data slices.

The method continues with step 100 where the storage unit determines a memory remapping cost based on the estimated memory remapping. To determine the memory remapping cost, the storage unit determines the memory remapping cost of relocating the encoded data slice to the memory device with respect to the storage unit and the memory remapping cost of moving the encoded data slice to the memory device with respect to the at least the memory mapping threshold number of storage units. The memory remapping cost includes one or more of processing time to transfer the encoded data slice to the memory device, effect on other operations of the storage unit, and change in accessibility of the encoded data slice when stored in the memory device. For example, the memory remapping cost considers whether the new memory device location has a higher or lower error rate, whether the new memory device has a longer or short life expectancy, etc.

The method continues with step 102 where the storage unit determines a memory remapping benefit based on the memory remapping cost. The storage unit determines the memory remapping benefit by determining a first memory remapping benefit for the storage unit based on the estimated memory remapping, determining a second memory remapping benefit for the at least the memory mapping threshold number of storage units based on the estimated memory remapping, and balancing the first memory remapping benefit, the second memory remapping benefit, the memory remapping cost with respect to storage unit, and the memory remapping cost with respect to the at least the memory mapping threshold number of storage units. For example, the storage unit may determine that while there is a benefit to moving an encoded data slice to a new memory device, the cost (e.g., the transfer time) to the storage unit lowers the overall benefit.

When the memory remapping benefit exceeds a threshold, the method continues with step 104 where the storage unit executes the estimated memory remapping of logical address space to physically addressable memory devices within the storage unit. When the memory remapping benefit does not exceed the threshold (e.g., the memory remapping cost is too high), the method branches back to step 98 where the storage unit determines a second estimated memory remapping based on the first memory mapping data, the first physical memory data, the memory mapping data, and the physical memory data. The method continues to step 100 where the storage unit determines a second memory remapping cost based on the second estimated memory remapping. The method continues to step 102 where the storage unit determines a second memory remapping benefit based on the second memory remapping cost. When the second memory remapping benefit exceeds the threshold, the method continues to step 104 where the storage unit executes the second estimated memory remapping of the logical address space to physically addressable memory devices within the storage unit.

As another example, the method begins at step 94 where a second storage unit of the DSN receives second memory mapping data and second physical memory data from each of at least the memory mapping threshold number of storage units of the set of storage units of the DSN, where the set of storage units does not include the second storage unit. The method continues with step 96 where the second storage unit obtains third memory mapping data and third physical memory data of the second storage unit. The method continues with step 98 where the second storage unit determines a second estimated memory remapping based on the third memory mapping data, the third physical memory data, the second memory mapping data, and the second physical memory data.

The method continues with step 96 where the second storage unit determines a second memory remapping cost based on the second estimated memory remapping. The method continues where the second storage unit determines a second memory remapping benefit based on the second memory remapping cost. When the second memory remapping benefit exceeds the threshold, the method continues with step 104 where the second storage unit executed the second estimated storage remapping of logical address space to physically addressable memory devices within the second storage unit.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
obtaining, by a storage unit of a dispersed storage network (DSN), memory mapping data and physical memory data from each of at least a memory mapping threshold number of storage units of a set of storage units of the DSN, wherein the at least the memory mapping threshold number of storage units does not include the storage unit;
obtaining, by the storage unit, first memory mapping data and first physical memory data of the storage unit;
determining, by the storage unit, an estimated memory remapping based on the first memory mapping data, the first physical memory data, the memory mapping data, and the physical memory data;
determining, by the storage unit, a memory remapping cost based on the estimated memory remapping;
determining, by the storage unit, a memory remapping benefit based on the memory remapping cost; and
when the memory remapping benefit exceeds a threshold, executing, by the storage unit, the estimated memory remapping of logical address space to physically addressable memory devices within the storage unit.

2. The method of claim 1 further comprises:
when the memory remapping benefit does not exceed the threshold:
determining, by the storage unit, a second estimated memory remapping based on the first memory mapping data, the first physical memory data, the memory mapping data, and the physical memory data;
determining, by the storage unit, a second memory remapping cost based on the second estimated memory remapping;
determining, by the storage unit, a second memory remapping benefit based on the second memory remapping cost; and
when the second memory remapping benefit exceeds the threshold, executing, by the storage unit, the second estimated memory remapping of the logical address space to physically addressable memory devices within the storage unit.

3. The method of claim 1, wherein the memory mapping data comprises:
a logical to physical address memory mapping from each of the at least the memory mapping threshold number of storage units, wherein each of the logical to physical address mapping of each storage unit of the at least the memory mapping threshold number of storage units includes a logical address having a common source name, a common data segment number, and a different pillar number.

4. The method of claim 1, wherein the physical memory data comprises one or more of:
number of memory devices used by the at least the memory mapping threshold number of storage units;
type of memory devices used by the at least the memory mapping threshold number of storage units;
read and write rates of each of the memory devices used by the at least the memory mapping threshold number of storage units;
input-output rates of each of the memory devices used by the at least the memory mapping threshold number of storage units;
simultaneous read and write capability of each of the memory devices used by the at least the memory mapping threshold number of storage units;
age of each of the memory devices used by the at least the memory mapping threshold number of storage units;
estimated life expectancy of each of the memory devices used by the at least the memory mapping threshold number of storage units;
error rates of each of the memory devices used by the at least the memory mapping threshold number of storage units;
storage capacity of each of the memory devices used by the at least the memory mapping threshold number of storage units; and
available memory space of each of the memory devices used by the at least the memory mapping threshold number of storage units.

5. The method of claim 1, wherein the at least the memory mapping threshold number comprises at least a decode threshold minus one number of storage units of the set of storage units, wherein the decode threshold number is a number of encoded data slices of a set of encoded data slices that are needed to recover a data segment of a data object, and wherein the set of encoded data slices are stored on the set of storage units.

6. The method of claim 1, wherein the determining the estimated memory remapping comprises:
determining, by the storage unit, to relocate an encoded data slice of a set of encoded data slices of a data object to a memory device within the storage unit, wherein the memory device is of a same type of memory device as used by other storage units of the at least the memory mapping threshold number of storage units to store the at least the memory mapping threshold number of encoded data slices of the set of encoded data slices, or wherein the memory device has a comparable input-output rate as the memory devices used by the other storage units to store the at least the memory mapping threshold number of encoded data slices, or wherein the memory device reduces the number of combinations of memory devices used by the other storage units of the at least the memory mapping threshold number of storage units to store the at least the memory mapping threshold number of encoded data slices of the set of encoded data slices.

7. The method of claim 6, wherein the determining the memory remapping cost comprises:
determining, by the storage unit, the memory remapping cost of relocating the encoded data slice to the memory device with respect to the storage unit, wherein the memory remapping cost includes one or more of: processing time to transfer the encoded data slice to the memory device, effect on other operations of the storage unit, and change in accessibility of the encoded data slice when stored in the memory device; and
determining, by the storage unit, the memory remapping cost of moving the encoded data slice to the memory device with respect to the at least the memory mapping threshold number of storage units.

8. The method of claim 7, wherein the determining the memory remapping benefit comprises:
determining, by the storage unit, a first memory remapping benefit for the storage unit based on the estimated memory remapping;
determining, by the storage unit, a second memory remapping benefit for the at least the memory mapping threshold number of storage units based on the estimated memory remapping; and
determining, by the storage unit, the memory remapping benefit by balancing the first memory remapping benefit, the second memory remapping benefit, the memory remapping cost with respect to the storage unit, and the memory remapping cost with respect to the at least the memory mapping threshold number of storage units.

9. The method of claim 1 further comprises:
receiving, by a second storage unit of the DSN, second memory mapping data and second physical memory data from each of at least the memory mapping threshold number of storage units of the set of storage units of the DSN, wherein the at least the memory mapping threshold number of storage units does not include the storage unit;
obtaining, by the second storage unit, third memory mapping data and third physical memory data of the second storage unit;
determining, by the second storage unit, a second estimated memory remapping based on the third memory mapping data, the third physical memory data, the second memory mapping data, and the second physical memory data;
determining, by the second storage unit, a second memory remapping cost based on the second estimated memory remapping;
determining, by the second storage unit, a second memory remapping benefit based on the second memory remapping cost; and
when the second memory remapping benefit exceeds the threshold, executing, by the second storage unit, the second estimated memory remapping of logical address space to physically addressable memory devices within the second storage unit.

10. A storage unit of a dispersed storage network (DSN), the storage unit comprises:
an interface;
memory; and
a processing module operably coupled to the memory and the interface, wherein the processing module is operable to:
obtain memory mapping data and physical memory data from each of at least a memory mapping threshold number of storage units of a set of storage units of the DSN, wherein the at least the memory mapping threshold number of storage units does not include the storage unit;
obtain first memory mapping data and first physical memory data of the storage unit;
determine an estimated memory remapping based on the first memory mapping data, the first physical memory data, the memory mapping data, and the physical memory data;
determine a memory remapping cost based on the estimated memory remapping;
determine a memory remapping benefit based on the memory remapping cost; and
when the memory remapping benefit exceeds a threshold, execute the estimated memory remapping of logical address space to physically addressable memory devices within the storage unit.

11. The storage unit of claim 10, wherein the processing module is further operable to:
when the memory remapping benefit does not exceed the threshold:
determine a second estimated memory remapping based on the first memory mapping data, the first physical memory data, the memory mapping data, and the physical memory data;
determine a second memory remapping cost based on the second estimated memory remapping;
determine a second memory remapping benefit based on the second memory remapping cost; and
when the second memory remapping benefit exceeds the threshold, execute the second estimated memory remapping of the logical address space to physically addressable memory devices within the storage unit.

12. The storage unit of claim 10, wherein the memory mapping data comprises:
a logical to physical address memory mapping from each of the at least the memory mapping threshold number of storage units, wherein each of the logical to physical address mapping of each storage unit of the at least the memory mapping threshold number of storage units includes a logical address having a common source name, a common data segment number, and a different pillar number.

13. The storage unit of claim 10, wherein the physical memory data comprises one or more of:
number of memory devices used by the at least the memory mapping threshold number of storage units;
type of memory devices used by the at least the memory mapping threshold number of storage units;
read and write rates of each of the memory devices used by the at least the memory mapping threshold number of storage units;
input-output rates of each of the memory devices used by the at least the memory mapping threshold number of storage units;
simultaneous read and write capability of each of the memory devices used by the at least the memory mapping threshold number of storage units;
age of each of the memory devices used by the at least the memory mapping threshold number of storage units;
estimated life expectancy of each of the memory devices used by the at least the memory mapping threshold number of storage units;
error rates of each of the memory devices used by the at least the memory mapping threshold number of storage units;
storage capacity of each of the memory devices used by the at least the memory mapping threshold number of storage units; and
available memory space of each of the memory devices used by the at least the memory mapping threshold number of storage units.

14. The storage unit of claim 10, wherein the at least the memory mapping threshold number comprises at least a decode threshold minus one number of storage units of the set of storage units, wherein the decode threshold number is a number of encoded data slices of a set of encoded data slices that are needed to recover a data segment of a data object, and wherein the set of encoded data slices are stored on the set of storage units.

15. The storage unit of claim 10, wherein the processing module is operable to determine the estimated memory remapping by:
determining to relocate an encoded data slice of a set of encoded data slices of a data object to a memory device within the storage unit, wherein the memory device is of a same type of memory device as used by other storage units of the at least the memory mapping threshold number of storage units to store the at least the memory mapping threshold number of encoded data slices of the set of encoded data slices, or wherein the memory device has a comparable input-output rate as the memory devices used by the other storage units to store the at least the memory mapping threshold number of encoded data slices, or wherein the memory device reduces the number of combinations of memory devices used by the other storage units of the at least the memory mapping threshold number of storage units to store the at least the memory mapping threshold number of encoded data slices of the set of encoded data slices.

16. The storage unit of claim 15, wherein the processing module is operable to determine the memory remapping cost by:
determining the memory remapping cost of relocating the encoded data slice to the memory device with respect to the storage unit, wherein the memory remapping cost includes one or more of: processing time to transfer the encoded data slice to the memory device, effect on other operations of the storage unit, and change in accessibility of the encoded data slice when stored in the memory device; and
determining the memory remapping cost of moving the encoded data slice to the memory device with respect to the at least the memory mapping threshold number of storage units.

17. The storage unit of claim 16, wherein the processing module is operable to determine the memory remapping benefit by:
determining a first memory remapping benefit for the storage unit based on the estimated memory remapping;
determining a second memory remapping benefit for the at least the memory mapping threshold number of storage units based on the estimated memory remapping; and
determining the memory remapping benefit by balancing the first memory remapping benefit, the second memory remapping benefit, the memory remapping cost with respect to the storage unit, and the memory remapping cost with respect to the at least the memory mapping threshold number of storage units.
